(19) United States
(12) Patent Application Publication
(10) Pub. No.: US 2014/0374681 A1
(43) Pub. Date: Dec. 25, 2014

(54) Stairway Assist Apparatus

(71) Applicant: Kenneth Brindamour, Johnston, RI (US)

(72) Inventor: Kenneth Brindamour, Johnston, RI (US)

(21) Appl. No.: 14/201,082

(22) Filed: Mar. 7, 2014

Related U.S. Application Data
(60) Provisional application No. 61/775,911, filed on Mar. 11, 2013.

(51) Int. Cl. E04F 11/18

(52) U.S. Cl. CPC E04F 11/1863; E04F 11/1802; E04F 11/18; B66B 2009/0876
USPC 256/65.16

(57) ABSTRACT

This apparatus helps mobility impaired individuals to walk up and down stairs and can reduce the incidence of stairway falls. A low-friction, high strength track is attached to a wall or banisters, running parallel to the rise of the stairs. A perpendicular cross rail assembly serves as a grip and a barrier to prevent falling. The cross rail slides along the track on a low-friction carriage. The user moves the cross rail up or down along the stairway one full step at a time. The cross rail locks into a fixed stopping position for travel to the next step. The fixed positions are adjustable. A counterweight reduces the force required for users to move the cross rail up or down stairs. A braking system is in place to lock the cross rail if a user falls.

### CROSS-REFERENCE TO RELATED APPLICATIONS

The present application claims priority from U.S. Provisional Application No. 61/775,911 filed Mar. 11, 2013, which is hereby incorporated herein by reference in its entirety.

### STATEMENT REGARDING FEDERALLY SPONSORED RESEARCH

Not applicable.

### NAMES OF THE PARTIES TO A JOINT RESEARCH AGREEMENT

Not applicable.

### REFERENCE TO A COMPACT DISC

Not applicable.

### BACKGROUND

This disclosure relates to a stairway safety and mobility assistance apparatus.

Prior art includes devices intended to help people traverse stairs. Certain issues with these devices inhibit full and effective use by mobility impaired persons. U.S. Pat. No. 7,950,498 by Stair Climbing Aid issued to Yang is an example of an assistance rail that spans the width of a stairway. Assistance rails that span across the stairs and attach to each side of the stairway create a barrier preventing the user from exiting the stairway.

U.S. Pat. 7,870,695 Support Apparatus and Method for Assisted Traversal of a Structure issued to Manson is an example of an assist rail attached to a single side of a stairway. In this and other prior art, rails that are attached to only one side of the stairway may be too weak to handle the full load of a falling person, and they often bind or get stuck during use.

Existing stairway assistance devices require a degree of muscle strength or fine motor manipulation that is beyond the ability of many mobility impaired individuals. The rails or barrier devices constructed are heavy and difficult for children or elderly users to manipulate.

Much of the prior art requires the user to exercise precise control of a stopping mechanism. The user may stop in a position that is either too far away, causing a dangerously extended reach, or too nearby, blocking full movement to the next step. Some devices have built-in stopping positions to overcome this problem, but those positions are not adjustable for ease of installation and for re-use on another stairway.

### SUMMARY

A stairway assist apparatus helps mobility impaired individuals to walk up and down stairs. A low-friction, high strength track is attached to a wall or banisters running parallel to the rise of the stairs. A cross rail assembly serves as a grip to hold onto and a barrier to prevent falling. It includes upper and lower rails to provide a larger barrier and unique grips for walking up and down. The cross rail slides along the track on a high strength, low-friction carriage. A counterweight is attached to the carriage so that the cross rail assembly is easy to move. The cross rail moves one full step at a time and locks into place for travel to the next step. The stop positions are fully adjustable to accommodate differences in stair construction. A self-retracting lifeline is attached to lock the cross rail if it accelerates quickly when a user trips or falls.

### BRIEF DESCRIPTION OF THE DRAWINGS

FIG. 1 is a perspective view of an apparatus being used by a person.

FIG. 2 is a perspective view of a track and adjustable stops.

FIG. 3 is a perspective view of a cross rail assembly.

FIG. 4 is a perspective view of a carriage.

FIG. 5 is a front view of the counterweight and self-retracting lifeline assemblies.

FIG. 6 is a front view of the telescoping cross rail.

FIG. 7A is a side view of a wheeled carriage and separate stop.

FIG. 7B is a front view of a wheeled carriage and separate stop.

### DETAILED DESCRIPTION

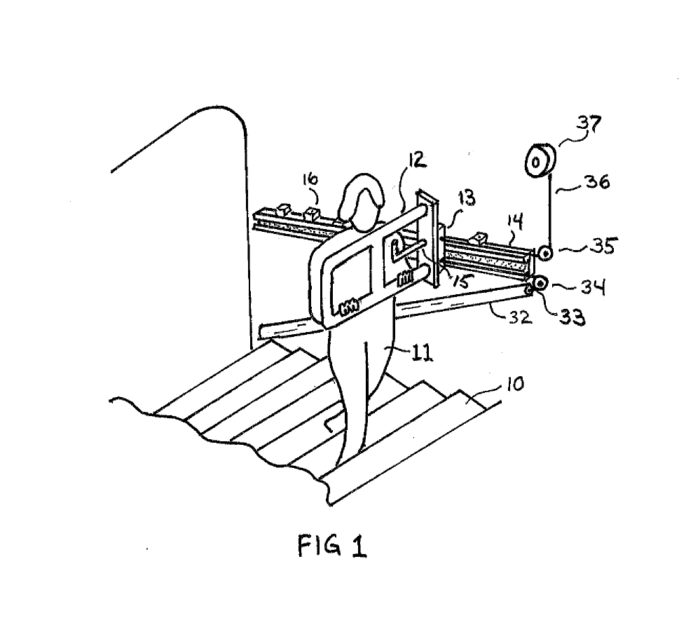

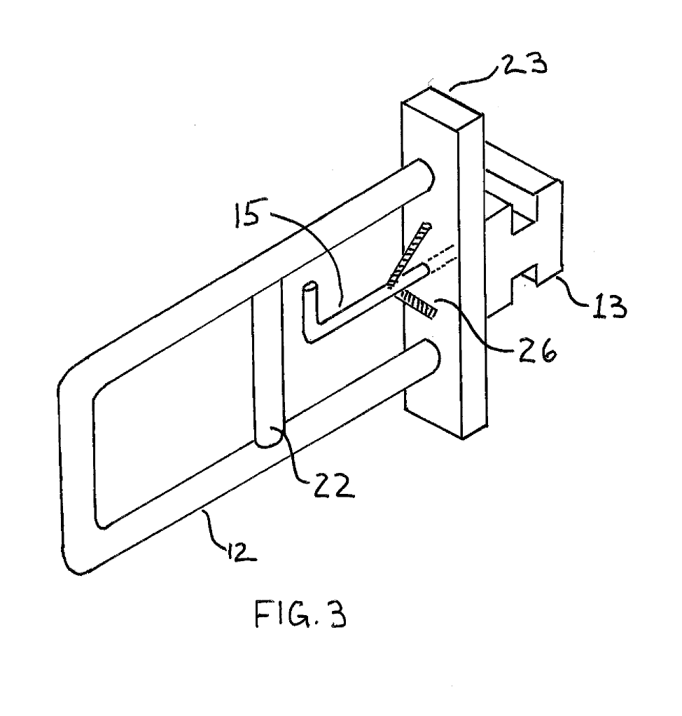

Several embodiments of the assist apparatus are shown and described in relation to the drawings. Referring to FIGS. 1 and 3, the cross rail assembly can be moved along the length of a stairway 10 by a user 11 moving either up or down stairs. The apparatus includes a low-friction track 14 mounted parallel to the rise of the stairs. The apparatus includes a cross rail assembly to be gripped by the user. The cross rail assembly consists of at least two bars or rails 12 that are parallel with the steps. A lower bar or rail is gripped to walk up the stairs, 4 while an upper bar or rail is gripped for descent. The cross rail assembly is attached to a carriage 13. In some embodiments, a cross rail base 23 will be used to join the carriage to the cross rail assembly. The carriage 13 includes bearings, wheels or low friction material so that it slides freely along the track. A plunger-lock 15 engages with adjustable stops 16 to prevent movement of the cross rail assembly down the stairs. The plunger-lock is disengaged by the user to initiate movement to the next step. One lock position exists for each step.

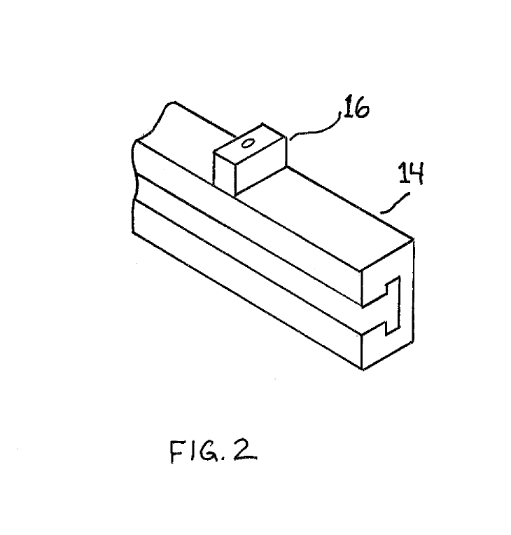

Referring to FIG. 2, the preferred embodiment includes a track 14 and adjustable stops 16. The track is securely attached to the wall and/or banister either with through bolts or with a bracket. The adjustable stops 16 may be attached to the track, or to the wall, or to a bracket attached to either the wall or track. One embodiment uses an extruded aluminum t-track rail.

Referring to FIG. 3, the preferred embodiment includes a cross rail assembly with upper and lower cross rails 12. The cross rail assembly includes a carriage 13. The cross rail and base may be attached to the carriage in any manner sufficient to handle the usage loads, including welding, bolts, and other attachment means. The cross rail assembly includes a sliding plunger-lock mechanism 15. The preferred embodiment includes a support bar 22 for strength and a base 23 to join the cross rails 12 to the carriage 13. The upper cross rail will be above the lower cross rail.

The sliding plunger-lock mechanism 15 includes a shaft that penetrates the cross rail assembly base 23 and the carriage 13 so that it can engage against 5 the adjustable stops 16. This prevents sliding of the cross rail assembly down the track 14. The plunger-lock mechanism also includes a handle and positive engagement device 26. In this embodiment, a spring is used for positive engagement; positive pressure will always push the mechanism into locked position unless the handle portion of the lock mechanism 15 is used to retract it. The handle can be moved by the user, away from the track, to unlock the cross rail assembly. The lock mechanism can include a key and slot to prevent unwanted rotation of the lock mechanism. The apparatus may also include a strap to keep the assembly in the unlocked mode.

The stop release mechanism may be intended for use by individuals that lack fine motor skills. A slap or swipe at the release handle may be sufficient to release the cross rail assembly for movement to the next step.

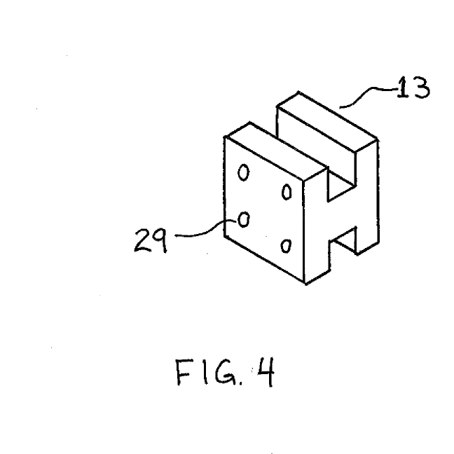

Referring to FIG. 4, the carriage 13 may take a range of shapes. It is the connection point between the track 14 and the cross rail assembly. The carriage will match the low friction design of the track, and will have sufficient strength to support the usage loads. FIG. 4 shows a carriage that is an H-shape profile, with threaded holes 29 so that the base 23 of the cross rail assembly may be bolted to it. The other T-shape engages the track 14.

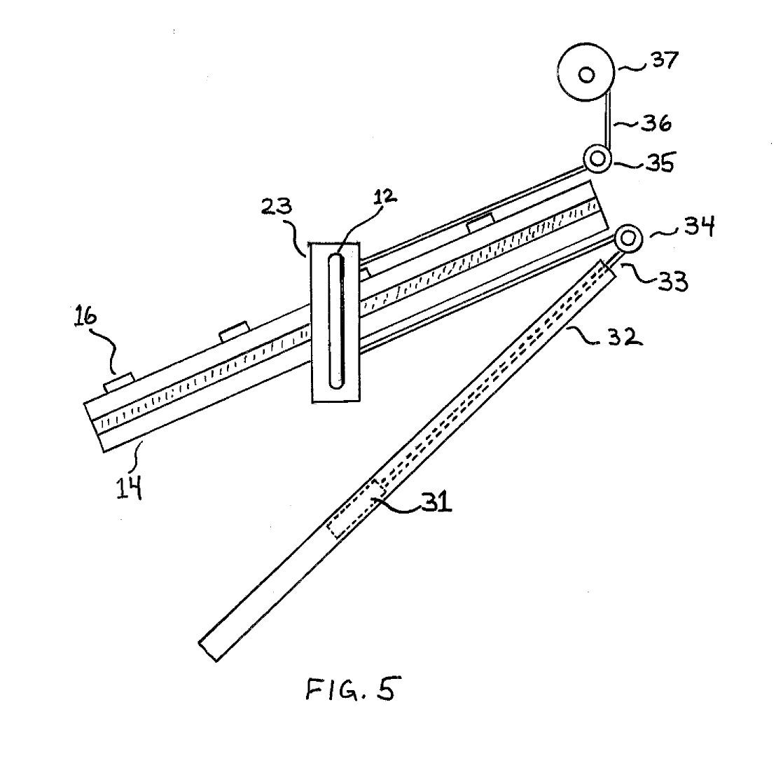

Referring to FIGS. 1 and 5, a counterweight 31 reduces the force needed for a user to move the cross rail 12 up the stairs. The counterweight 31 slides in a slide-way 32 that is fastened to the wall at an angle so that it is steeper than the stairway. The counterweight 31 is attached to the carriage 13 by a cable 33 that runs through a pulley 34.

Referring to FIGS. 1 and 5, one embodiment includes a self-retracting lifeline 37 to prevent rapid acceleration of the cross rail 12. In one embodiment, the self-retracting lifeline 37 is attached to the carriage 13 by a cable 36 that runs through a pulley 35. The pulling force is up the stairs, and the self-retracting lifeline 37 will lock movement of the carriage 13 if it accelerates due to the fall of a user. In an embodiment, cable 36 runs through an anchored centrifugal brake mechanism so that the brake locks if the cable is moved very quickly, as in a fall.

The apparatus may also include a retrieval system. The purpose of the retrieval mechanism is to move the cross rail assembly toward the user if the assembly was last left at the other end of the stairs. A reel is attached to one end of a cable. The other end of the cable is attached to the carriage 13. The reel is turned manually to retrieve the assembly. Reels are positioned at the top and bottom of the track. A strap can be used to keep the locking mechanism in the unlocked mode for retrieval. The cables for the retrieval system and for the braking system can ride inside of a cableway that runs parallel to the track.

A child barrier attachment can be used in some embodiments. The child barrier attachment attaches to the cross rail assembly so that it extends to the nose of a step, and across the width of the stairway. One embodiment uses hooks to hand the child barrier from the top or bottom rail. Another embodiment uses screws to attach the child barrier to the cross rail assembly. Another embodiment uses a hook and loop system such as Velcro™ to attach the child barrier to the cross rail assembly.

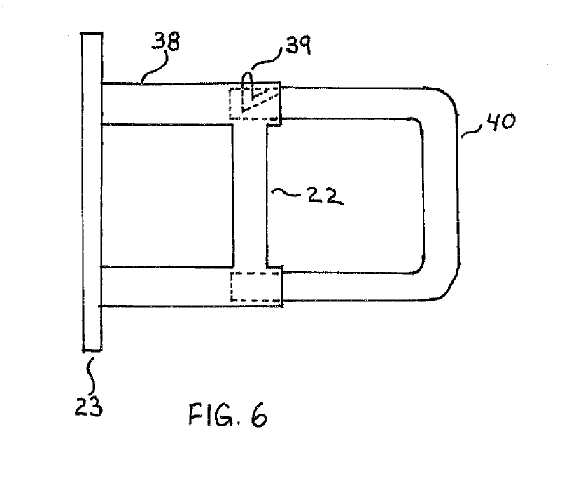

Referring to FIG. 6, one embodiment includes a cross-rail that telescopes to reduce the width of the apparatus across the entrance to a stairway when it is not in use. The fixed cross-rail 38 and support bar 22 are joined together and attached in a fixed way to the base 23. Fixed cross-rail 38 has a through-hole for spring-loaded location pin 39. Telescoping cross-rail 40 has an outside diameter that fits within the inside diameter of fixed cross-rail 38 and has a through-hole for spring-loaded location pin 39. The spring-loaded location pin 39 is fixedly attached to the inside of telescoping cross-rail 40 with constant outward pressure. A user pushes down the pin 39 and pushes telescoping cross-rail 40 to retract inside of fixed cross rail 38.

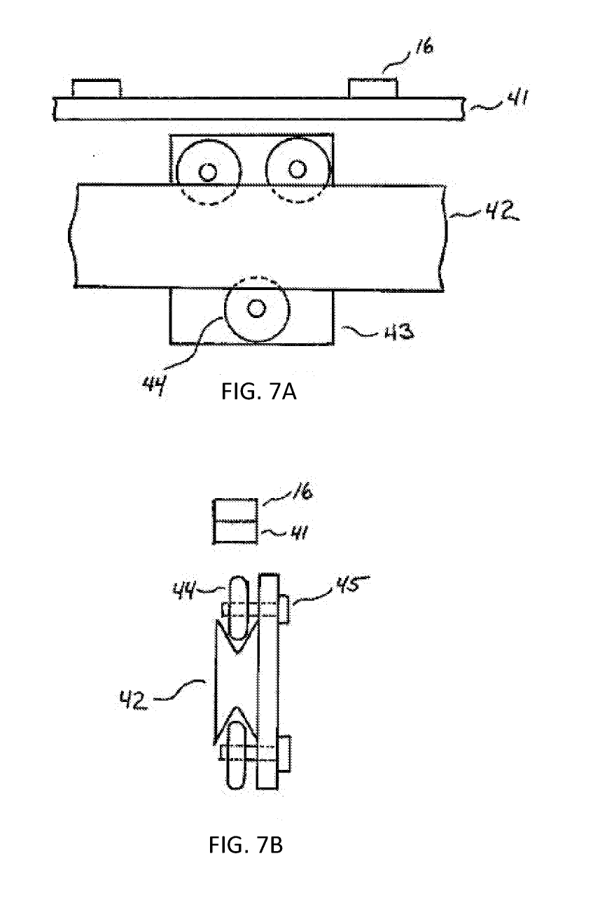

Referring to FIG. 7A and FIG. 7B, in one embodiment, the track may be split into two parallel sections. The main track 42 provides a guide for wheels 44. The adjustable-stop track 41 is parallel with the main track 42 and the adjustable stops 16 are attached to track 41. The wheels 44 are attached to carriage 43 by axles 45.

Other embodiments may include various features.

In one embodiment, the apparatus can be used to move up or down a ramp instead of stairs.

In one embodiment that does not use stop blocks, the lock mechanism penetrates stop holds in the track, the wall, or an attachment that runs parallel to the track. The lock shaft engages with the downhill side of the stop hold to prevent movement.

One embodiment includes a stainless steel track and ball bearing carriage. One embodiment uses two parallel tracks to support the cross rail assembly.

One embodiment of the cross rail assembly includes additional parallel rails between the upper and lower rails to accommodate users of different heights. One embodiment includes a hinge so that the cross rail may swing out of the way. One embodiment includes a bracket and pocket/slot so that the cross rail may be removed from the carriage when not in use.

One embodiment of the cross rail omits the end section, the support bar, or both.

Other embodiments may use alternative locking/unlocking mechanisms and include actuators, including a cable and lever arrangement.

Other embodiments achieve the unlocked position by use of alternative restraints to hold the lock mechanism in the unlocked positions, such as a slide, or clip.

Other embodiments attach the base to the carriage using a different number of bolts, use pins, or use a welded or chemically joined attachment.

In one embodiment, the carriage is fabricated so that the base is not used and the cross rails attach directly to the carriage.

In one embodiment, a different brake mechanism is used to stop movement of the cross rail assembly if a fall is detected.

In one embodiment, electronic gauges sense a fall and force the lock mechanism to engage, so that the lock mechanism doubles as a brake.

In one embodiment, the retrieval reel is turned by a motor. In one embodiment, the cable is a continuous loop and is grasped directly by the user to manage the retrieval without a reel.

1. An apparatus to assist mobility impaired individuals to walk up and down a stairway, the apparatus comprising:
a track attached to a wall or banister, the track substantially parallel to a rise of the stairway;
a carriage coupled to the track to allow the carriage to travel freely along the track without binding;
a cross rail assembly fixed to the carriage and positioned substantially parallel to the stairs and substantially perpendicular to the track; and
a stopping mechanism that locks the carriage in place at one or more set positions that each correspond to a step of the stairway.

2. The apparatus of claim 1, where the stopping mechanism is a plunger assembly having a shaft positioned through a hole in the carriage to engage one or more stops positioned along the stairway.

3. The apparatus of claim 3, where a position of one or more of the stops is adjustable.

4. The apparatus of claim 1, wherein the cross rail assembly comprises at least a top rail situated at a first height relative to the stairway that can be gripped by the mobility impaired individual while walking down the stairway and a bottom rail situated at a second height relative to the stairway that can be gripped by the mobility impaired individual while walking up the stairway, wherein the top rail is positioned above the bottom rail.

5. The apparatus of claim 1, where the cross rail assembly includes a telescoping member having at least a first position to shorten a length of the cross rail assembly to allow clearance on the stairway and a second position to increase the length of the cross rail to allow the cross rail assembly to be gripped by the mobility impaired individual during use.

6. The apparatus of claim 1, further comprising a self-retracting lifeline comprising a cable attached to the carriage, the self-retracting lifeline configured to halt movement of the carriage if the carriage accelerates due to a fall of the mobility impaired individual.

7. The apparatus of claim 1, where the carriage engages the track by means of a t-slot.

8. The apparatus of claim 1, where the carriage engages the track by means of wheels.

9. The apparatus of claim 2, further comprising a second track to which the stops are adjustably attached.

10. The apparatus of claim 1 further comprising a counterweight coupled to the carriage and a slide-way along which the counterweight travels, the slide-way positioned at an angle that is steeper than the rise of the stairway.

11. The apparatus of claim 10 including a cable that attaches the counterweight to the carriage and allows the counterweight to travel along the slide-way.

12. The apparatus of claim 1 wherein the cross rail assembly includes a cross rail base member fixed to the carriage and to two or more cross rails coupled to the cross rail base member.

13. The apparatus of claim 1 wherein a mechanical coupling between the carriage and the track has sufficiently low friction to allow the carriage and cross rail assembly to slide along the track.

14. The apparatus of claim 2 wherein at least one of the stops is positioned on a wall, on the track, or on a bracket attached to the wall or the track.

15. An apparatus comprising:
a track attached to a wall or banister and positioned substantially parallel to a rise of a stairway;
a carriage
a mechanical coupling between the carriage and the track, the mechanical coupling having sufficiently low friction to allow the carriage to travel along the track without binding;
a cross rail assembly comprising:
a cross rail base member fixed to the carriage;
a first cross rail positioned substantially parallel to the stairs and substantially perpendicular to the track at a first height relative to the stairway to allow a user to grip the first cross rail while moving up the stairway; and
a second cross rail positioned substantially parallel to the stairs and substantially perpendicular to the track at a second height relative to the stairway to allow the user to grip the second cross while moving down the stairway; and
a stopping mechanism comprising:
a plunger having a shaft positioned through a hole in the carriage;
one or more stops each positioned relative to a stair of the stairway; and
a positive engagement mechanism that positions the plunger in a default position to engage the plunger against the one or more stops so that the carriage and cross rail assembly stop at one or more stairs of the stairway; and
a handle to allow the user to disengage the stopping mechanism to allow the carriage and cross rail assembly to move to a next stop; and
a braking mechanism configured to detect whether the user falls, and to automatically stop the carriage and cross rail assembly if the user falls.

16. The apparatus of claim 15 wherein the positive engagement mechanism comprises a spring configured to hold the plunger in the default position.

17. The apparatus of claim 15 further comprising a slide-way through which the counterweight travels.

18. The apparatus of claim 15 wherein the braking mechanism comprises a gauge to sense a fall of the user and a self-retracting lifeline to lock the cross rail assembly if a fall is detected.

19. The apparatus of claim 15 wherein the mechanical coupling comprises wheels attached to the carriage, the track, or both.

20. The apparatus of claim 15 wherein the mechanical coupling comprises a t-shaped slot in the track and a t-shaped tab on the carriage.

21. The apparatus of claim 15 further comprising a counterweight attached to the carriage and configured to travel at an angle steeper than a rise of the stairway to assist the user in moving along the stairway.
